(19) United States
(12) Patent Application Publication
(10) Pub. No.: US 2025/0278176 A1
(43) Pub. Date: Sep. 4, 2025

(54) MEDIA PLAYBACK CONTROLLER

(71) Applicant: GOOGLE LLC, Mountain View, CA (US)

(72) Inventors: Megan L. Fu, San Francisco, CA (US); Claire Tauziet, Redwood City, CA (US); Yeun Su Shin, San Francisco, CA (US); Jiaming Cheng, Santa Clara, CA (US)

(21) Appl. No.: 19/068,770

(22) Filed: Mar. 3, 2025

Related U.S. Application Data
(60) Provisional application No. 63/560,145, filed on Mar. 1, 2024.

(51) Int. Cl. G06F 3/0484; G06F 3/0482; G06F 3/16

(52) U.S. Cl. CPC G06F 3/0484; G06F 3/0482; G06F 3/165

(57) ABSTRACT

A method may determine that an application operable to play a media file has lost focus. A method may in response to determining that the application has lost focus, initiating a display of a user interface including a playback control for the media file accessible via the operating system, wherein the user interface has a second state and first state and is initially displayed in a first state within a task bar and playback of the media file is controllable using the playback control.

### CROSS-REFERENCE TO RELATED APPLICATION

This application claims priority to U.S. Provisional Patent Application No. 63/560,145, filed on Mar. 1, 2024, the disclosure of which is incorporated by reference herein in its entirety.

### BACKGROUND

Users often access a number of different applications on a computing device to listen to, and or watch media. Some applications play audio files while others play videos or any combination thereof.

### SUMMARY

In some aspects, the techniques described herein relate to a method performed by an operating system, the method including: determining that an application operable to play a media file has lost focus; and in response to determining that the application has lost focus, initiating a display of a user interface including a playback control for the media file accessible via the operating system, wherein the user interface has a second state and a first state and is initially displayed in the first state within a task bar and playback of the media file is controllable using the playback control.

In some aspects, the techniques described herein relate to a system including: a processor; and a memory configured with code operable to: determine that an application operable to play a media file has lost focus; and in response to determining that the application has lost focus, initiate a display of a user interface including a playback control for the media file accessible via an operating system, wherein the user interface has a maximized state and minimized state and is initially displayed in the minimized state within a task bar and playback of the media file is controllable using the playback control.

In some aspects, the techniques described herein relate to a non-transitory computer-readable medium storing instructions that, when executed by a processor, cause a processor to: determine that a browser tab operable to control playback of a media file has lost focus; and in response to determining that the browser tab has lost focus, initiate a display of a user interface in a maximized state including a playback control for the media file accessible via an operating system, wherein the user interface is initially displayed in a minimized state within a task bar and playback of the media file is controllable based on the playback control.

### BRIEF DESCRIPTION OF THE DRAWINGS

FIG. 1A depicts an application that plays media, according to examples described throughout this disclosure.

FIG. 1B depicts a media user interface including a playback control setting, according to examples described throughout this disclosure.

FIG. 1C depicts a media user interface displayed in a minimized state within an operating system task bar, according to examples described throughout this disclosure.

FIG. 1D depicts a media user interface displayed in a minimized state within an operating system task bar, according to examples described throughout this disclosure.

FIG. 1E depicts a media user interface displayed in a minimized state within an operating system task bar, according to examples described throughout this disclosure.

FIG. 1F depicts a media user interface including a playback control setting, according to examples described throughout this disclosure.

FIG. 2A depicts a media user interface displayed in a minimized state within an operating system task bar, according to examples described throughout this disclosure.

FIG. 2B depicts a media user interface including a playback control setting, according to examples described throughout this disclosure.

FIG. 3A depicts a media user interface including a playback control setting, according to examples described throughout this disclosure.

FIG. 3B depicts a media user interface including a playback control setting, according to examples described throughout this disclosure.

FIG. 4A depicts a media user interface including a device selection control, according to examples described throughout this disclosure.

FIG. 4B depicts a media user interface including a device selection control, according to examples described throughout this disclosure.

FIG. 4C depicts a media user interface including a device selection control, according to examples described throughout this disclosure.

FIG. 5A depicts a media user interface including a transfer control, according to examples described throughout this disclosure.

FIG. 5B depicts a media user interface including a transfer control, according to examples described throughout this disclosure.

FIG. 5C depicts a media user interface including a transfer control, according to examples described throughout this disclosure.

FIG. 6. depicts a system diagram that may be used to perform the methods described herein, according to examples.

FIG. 7 depicts a flow chart of method 700, according to examples.

### DETAILED DESCRIPTION

The present disclosure describes a media user interface operable to allow a user to control the playback of one or more media files via an operating system control provided by the operating system. In examples, the media user interface may allow a user to playback media files opened by one or more applications from a control displayed in a task bar. When an application playing a media file loses focus (for example, when an application window is minimized or another application or tab is selected), the operating system may be configured to display a media user interface above the task bar for a short period of time to make the user aware of the operating system playback control options. In examples, the media user interface may allow a user to skip interruptive content (e.g., advertisements) in a media file, jump to timeline locations in a media file, cast the media file to other devices (internal or external), and/or continue playing a media file previously played from other devices.

Some users may wish to play media files on a computing device while they do other work. The application may display an application window 100 that gets in the way of other application windows that a user wishes to engage, however, especially when the user wishes to listen to the media files in the background while doing work. In addition, some users may have multiple media files open, possibly in multiple applications while they use their computing devices to execute other tasks. It is a technical problem that user interface elements for controlling the media (e.g., for skipping ads, volume controls, next chapter controls, pause controls, etc.) are part of the user interface provided by the application playing the media file and, thus, not always visible or readily identifiable when the application window (or tab) loses focus. Thus, such application-based controls can cause user friction to switch between applications to, for example, pause a media file or skip interruptive content, while working on other tasks. Interruptive content is content that is not part of the media file being played, such as an advertisement that is added to (interrupts) the payback of the media file.

The present disclosure provides the technical solution of providing a media user interface with playback control settings in an operating system task bar, which is easily accessible and can provide playback controls for any application operable to control playback of a media file. By displaying the media user interface when an application loses focus, a user may access the playback control settings without needing to switch contexts. Playback of a media file includes live streaming of a media file.

As used herein, an application operable to control playback of a media file includes applications that execute independently of a browser application. Such applications may also be referred to as native applications. As used herein, an application operable to control playback of a media file includes applications that execute within a browser tab.

Such an application may also be referred to as a web application. A web application executes in a browser tab, but the browser does not provide the content displayed in the tab. Thus, while a web application executes in a browser tab of a browser window, the browser itself does not control playback of the media file. Instead, the web application controls the playback. Thus, a web application operable to control playback of a media file may lose focus when the user selects another tab of the browser, but the browser does not lose focus. While a web application may execute within a browser tab, the user interface may lack one, some, or all of the user interface elements of a conventional browser tab, such as an address input area, a refresh control, a forward button, a back button, etc. For ease of explanation, a web application executing within a browser tab may also be referred to herein as a browser tab. Thus, a browser tab operable to playback a media file is understood to refer to the application executing with that browser tab being operable to playback the media file.

In examples, losing focus may mean that an application, a window, a web application, a browser, or a browser tab change to executing in a background process. In examples, losing focus may mean that an application, a window, a web application, a browser, or a browser tab change from executing in a foreground process to executing in a background process. In examples, executing in a foreground process may mean the application is actively interacting with and/or available to receive inputs from a user, typically via a visible graphical user interface or window. Executing in a background process may mean that the application is not presently interacting with a user or accepting user inputs. In examples, a background process may not be associate with a graphical user interface element that is being displayed. In examples, foreground processes may have a higher priority than background processes.

The operating-system-provided playback controls offer simplified access to one or more playback controls for the one or more media files. Multiple media files opened by one or more applications may be controllable via a centralized operating system media user interface while the applications are in the background.

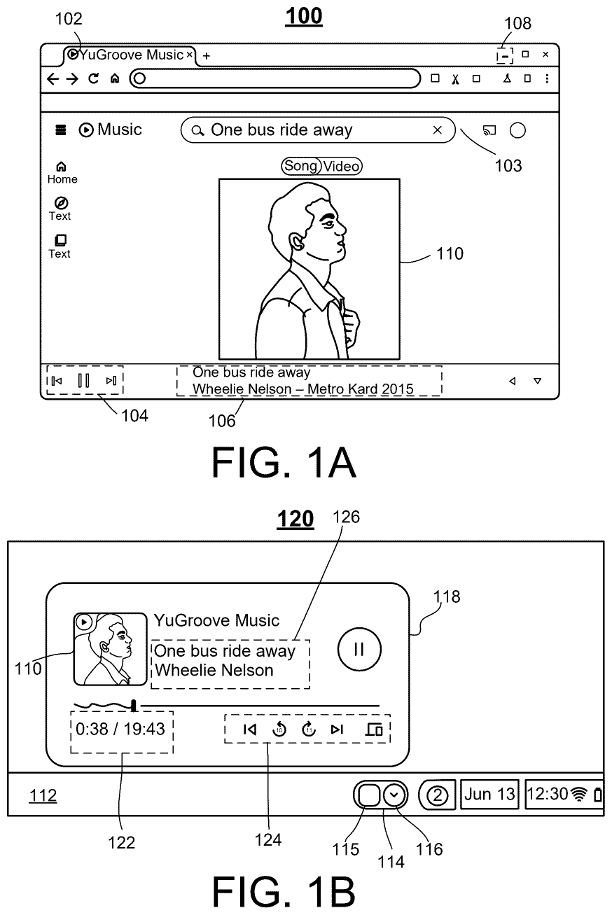

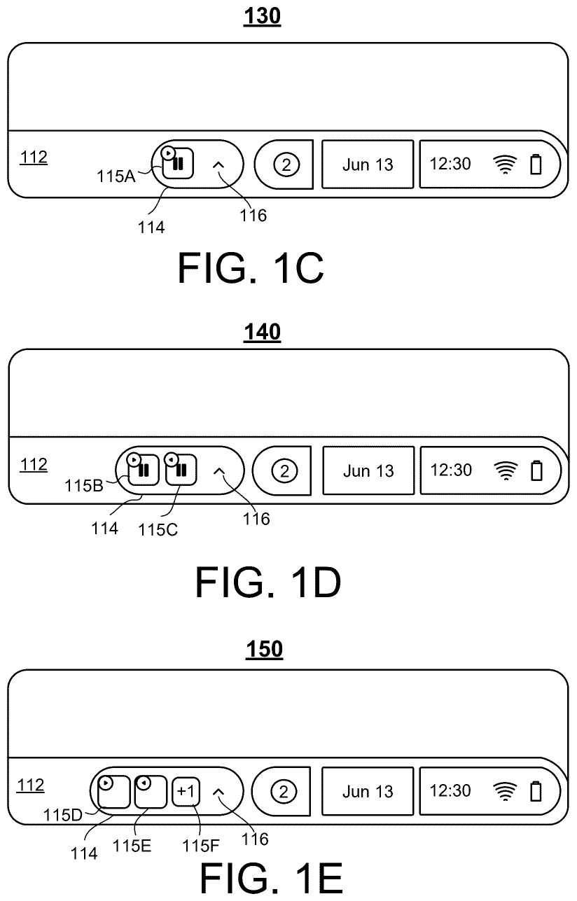

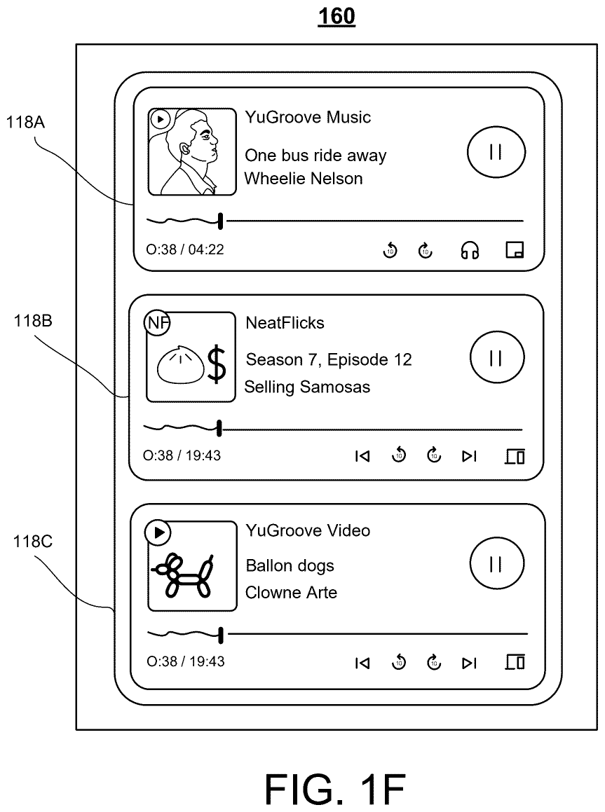

In the example of FIG. 1A, the application may render application window 100, which may be operable to control the playback of a media file, such as a music file or a video file. In examples, the application may execute on top of an operating system. In some examples, the operating system may be a browser-based operating system. In examples, the application that initiates display of the content in the application window 100 may be a web application that executes in a browser window or a browser tab, for example. In examples, application window 100 may be any window generated by an application executing on the operating system without executing in a browser tab.

When application window 100 opens a media file, the application may open a media session object with the operating system. The media session object may allow the application to share information about the media file with the operating system. In some implementations, the media session object enables the application to use resources of the computing device, such as the speakers, to play the media file.

For example, FIG. 1A depicts example application window 100, a web application executing within a browser tab. A web application is used in the following figures for ease of discussion, but the figure and the discussion is not intended to be limiting. Application window 100 is also understood to represent an application window generated by an application that executes independently of a browser application.

In the example of FIG. 1A, application window 100 is generated by a web application executing within a tab of a browser application, e.g., with a tab 102 open to the web application, YuGroove Music. Within tab 102, YuGroove Music provides a search bar 103 in which a user has typed, “One bus ride away”. In an example, a set of application playback controls 104 include a pause/play control, a rewind control, and a fast forward control. An informational display 106 includes the title of a song, the artist, and album associated with the media file. The example web application YuGroove may further include a display of cover art 110 associated with the media file.

In examples, the media session object may further allow the application to delegate playback control of the media file to the operating system. The operating system may maintain a list of open media session objects associated with one or more applications. In examples, the operating system may check for an action handler for one or more playback control operations (i.e., the W3C standard provides a media session object with related action handlers: https://www.w3.org/TR/mediasession/#actions-model). If an action handler is not available via a media session object, the operating system may not support a playback control operation or may support a smaller subset of playback control operations. In examples, the operating system may support playback control for actions that are based on the video itself, such as play, pause, fast forward, rewind, etc.

In examples, the operating system may display a media user interface in the operating system task bar. The operating system task bar is a bar at the edge of a display of a graphical user interface for the operating system. The task bar allows quick access to, among other things, current or favorite applications, open (executing applications), widgets (e.g., a calendar widget), etc. In examples, the operating system task bar may display the media user interface in a notifications area. In examples, the operating system task bar may display the media user interface in a currently running application area of the operating system task bar.

FIG. 1B depicts a portion of an operating system interface 120 including an operating system task bar 112. In examples, the operating system may display a media user interface when the application opens a media session object for the media file. In examples, the media user interface may be displayed in a minimized state, for example minimized media user interface 114, in operating system task bar 112, or in a maximized state, for example a maximized media user interface 118.

When in a minimized state, the media user interface may include a subset of playback controls available when the media user interface is not in a minimized state. In a minimized state, the media user interface may include an icon that represents a single playback control. In a minimized state, the media user interface may be smaller than when in a maximized state. Upon selection of a media user interface in a minimized state, the maximized state of the media user interface may be displayed.

Minimized media user interface 114 may provide information to a user about one or more media files that are open and available to be played via one or more application windows. Minimized media user interface 114 may further allow for playback control of one or more media files at the operating system by a user.

In examples, minimized media user interface 114 may include a playback control 115. In examples, playback control 115 may include an icon representing a media file. For example, playback control 115 may include a miniature version of cover art 110. In examples, playback control 115 may include an icon representing application window 100 (e.g., a favicon). In further examples, playback control 115 may include any combination of cover art 110 and/or an icon representing application window 100.

In examples, playback control 115 may include any combination of: of a play control, a pause control, a fast forward control, and a rewind control. In examples, playback control 115 may include a play and pause control, for example a toggle control that may be used to play and/or pause a media file.

FIGS. 1C-1E depict a further three instances of minimized media user interface 114 within operating system task bar 112. FIG. 1C depicts operating system interface 130 including example playback control 115A, FIG. 1D depicts operating system interface 140 including example playback control 115B, and FIG. 1E depicts operating system interface 150 with example playback control 115C. Operating system interface 130 includes a playback control 115A. In the example of the figure, playback control 115 is a toggle control to play or pause a media file. After the media file begins playing, a pause symbol may be displayed to indicate that selecting the playback control again may pause the media file. This may be seen in FIG. 1C, where playback control 115A includes a pause symbol.

The example minimized media user interface 114 of FIG. 1D includes a playback control 115B and a playback control 115C. Playback control 115B may be associated with a first media file and playback control 115C may be associated with a second media file. A first application may be playing the first media file and the second media file. A first application may be playing the first media file and a second application may be accessing and/or playing the second media file. In the example, any combination of media files associated with playback control 115B and playback control 115C may be playing. Toggling playback control 115B may pause/play the first media file. Toggling playback control 115C may pause/play the second media file.

The example minimized media user interface 114 of FIG. 1E includes a playback control 115D, a playback control 115E, and a playback control 115F. Playback control 115D may be associated with a first media file, playback control 115E may be associated with a second media file, and a playback control 115F may be associated with at least a third media file. In the example, the media files associated with each of playback control 115D and playback control 115E may be played/paused by toggling the respective control. In the example of FIG. 1E, playback control 115F may include a “+1” symbol, however. In examples, playback control 115F may indicate that there is a playback control for one or more additional media files available that is not being displayed in the minimized media user interface 114 and may be displayed if playback control 115F is selected.

Returning to FIG. 1B, in examples, minimized media user interface 114 may further include a dropdown menu 116. Dropdown menu 116 may be used to initiate display of a maximized media user interface 118 adjacent to the operating system task bar 112. Maximized media user interface 118 is an expanded version of minimized media user interface 114. In the maximized state, the maximized media user interface 118 includes additional controls and information associated with the media file beyond what is provided in the minimized media user interface 114. In examples, the maximized media user interface 118 may display all additional controls and information by default when displayed.

In examples, maximized media user interface 118 may include any combination of one or more playback controls 124, informational display 126, cover art 110, playtime and/or time remaining 122, in addition to other controls and informational features.

Returning to FIG. 1A, it may be seen that application window 100 may include a minimize control 108. Upon selection of minimize control 108 (e.g., in response to detection of the application window 100 losing focus), the operating system may hide application window 100 and initiate display of maximized media user interface 118, as seen in FIG. 1B.

In examples, when application window 100 loses focus (e.g., is minimized or the user selects another tab/window), maximized media user interface 118 may be displayed for a discrete amount of time (for example 5 seconds) above operating system task bar 112 to allow the user to become aware that a media file may be accessed and controlled via minimized media user interface 114 in operating system task bar 112.

FIG. 1F depicts an operating system interface 160 with a rendering of three instances of user interface 118, including user interface 118A, user interface 118B, and user interface 118C, one for each of three different media files. The three instances provide an example of what may be displayed in response to selection of dropdown menu 116 in FIG. 1E. Each instance of user interface 118 may provide playback controls and information available for a respective media file.

In examples, a media file associated with application window 100 may continue playing when application window 100 loses focus. Playback control may be accessed subsequently via minimized media user interface 114, maximized media user interface 118, or by activating application window 100 again (i.e., application window 100 receiving focus).

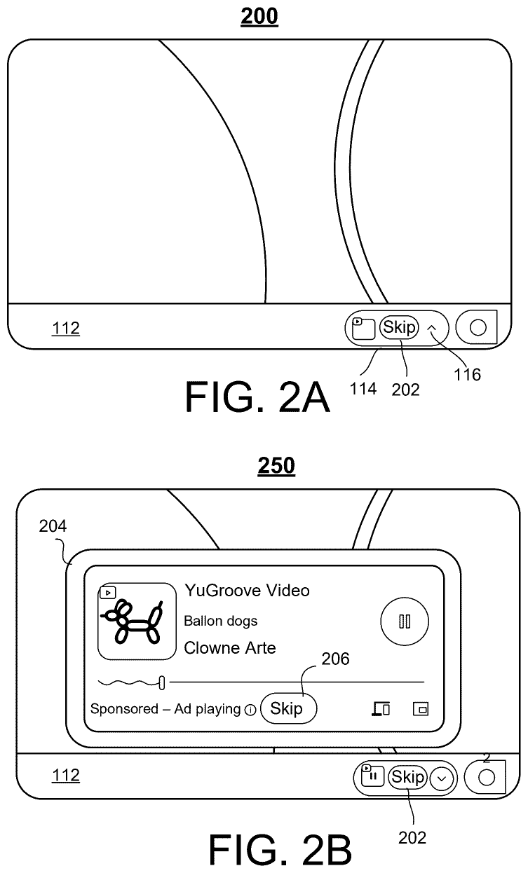

FIG. 2A depicts an operating system interface 200 with operating system task bar 112 with a minimized media user interface 114 that includes an interruptive content bypass control 202. An interruptive content bypass control 202 may be operable to skip over an interruption in the playback of the media file, such as an advertisement, upon selection by a user. The application may provide its own bypass control, but this bypass control is hidden when the application window 100 has lost focus, e.g., is covered by another window, either partially or wholly. In examples, upon selecting dropdown menu 116, a media user interface may be displayed. For example, FIG. 2B depicts an operating system interface 250 including a rendering of user interface 204. User interface 204 may further include a bypass control 206. In examples, the user interface 204 may include other information to inform the user that an interruption is playing, such as text explaining, “Sponsored-Ad playing”.

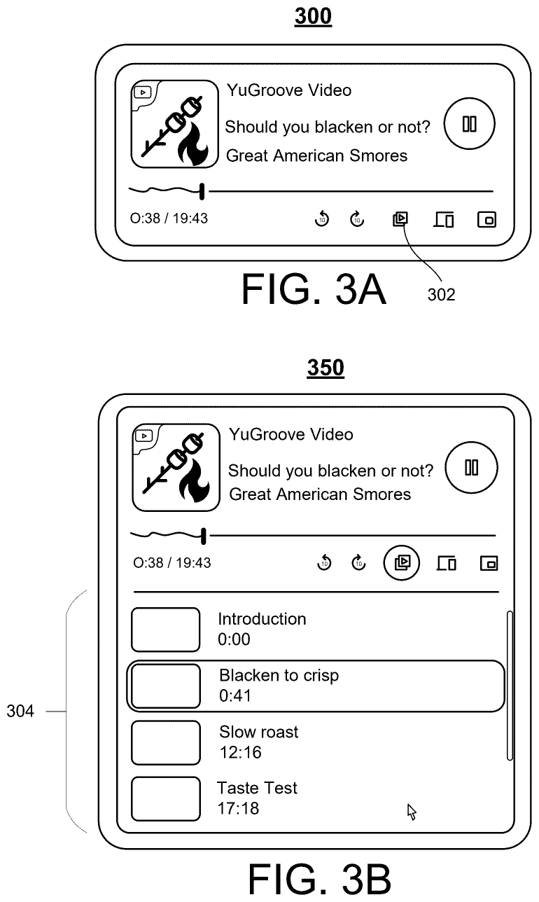

In examples, a media user interface may include one or more selectable timeline controls. For example, FIG. 3A depicts a media user interface 300 and FIG. 3B depicts an expanded media user interface 350. Media user interface 300 includes a timeline control 302. Timeline control 302 may be selected to expand media user interface 300 into expanded media user interface 350. Expanded media user interface 350 may enable a user to view a number of selectable positions 304 in the timeline of the media file. In the example, the position titled “Should you blacken or not?” from the media file “Great American Smores” is currently being played.

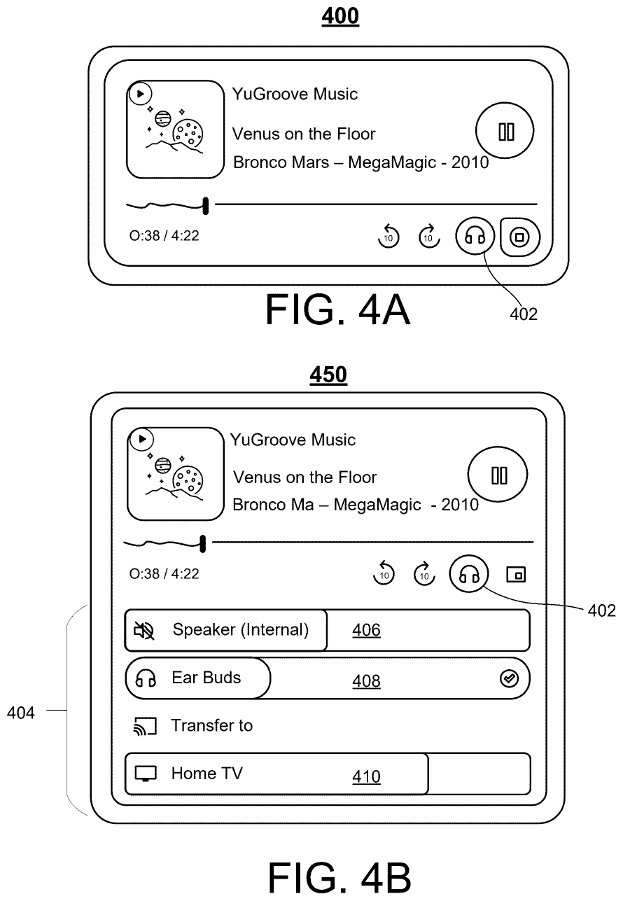

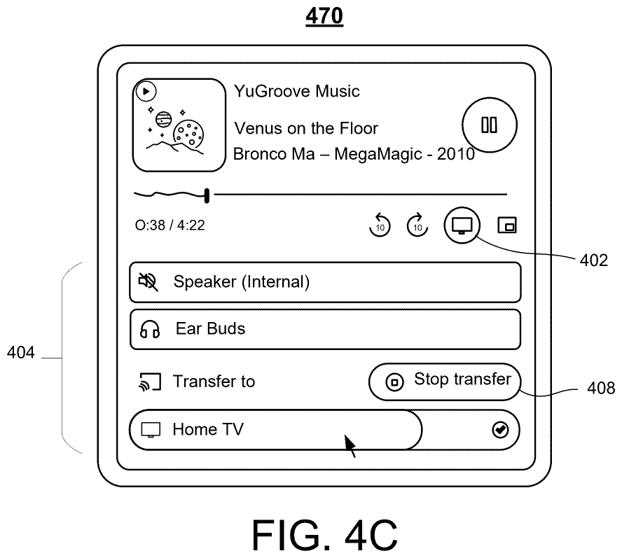

In examples, it may be possible to select other devices in communication with the operating system, either internally or externally, to play or cast a media file to. For example, FIG. 4A depicts a media user interface 400, FIG. 4B depicts an expanded user interface 450, and FIG. 4C depicts an expanded user interface 470. Media user interface 400 includes a playback device selection control 402. Playback device selection control 402 may be selected by a user to expand media user interface 400 into expanded user interface 450 and view a number of selectable device controls 404 available to play the media file on one or more local devices or transfer devices. In examples, local devices may include devices that the operating system may stream or transmit a media file to directly to play. Transfer devices may include devices that play a media file received directly from another source that isn't the operating system, such as the Internet. In other words, upon transferring the playback of the media file to the transfer device, the local device does not stream the media file to the transfer device for playback. In examples, the operating system may transfer playing a media file to or from the transfer device upon user command. In examples, a number of selectable device controls 404 may include local devices, including but not limited to: a speaker control 406 and an ear buds control 408, and a transfer control including but not limited to: a television control 410. In example, an icon visible on playback device selection control 402 may change to indicate what kind of device control has been selected. For example, if ear buds are selected the icon may represent ear buds (see FIG. 4B), and if a television or other display is selected a screen may be depicted (see FIG. 4C). In response to receiving a selection of the selectable device controls 404, the operating system may send an instruction to a selected device to play the media file. In examples, expanded user interface 450 and/or expanded media user interface 470 may offer an option to stop playing or a media file on a local device or transfer device. For example, in expanded user interface 470 a media file is being transferred to a smart TV. A stop transferring control 408 may be selected by a user to stop casting the media file to the smart TV.

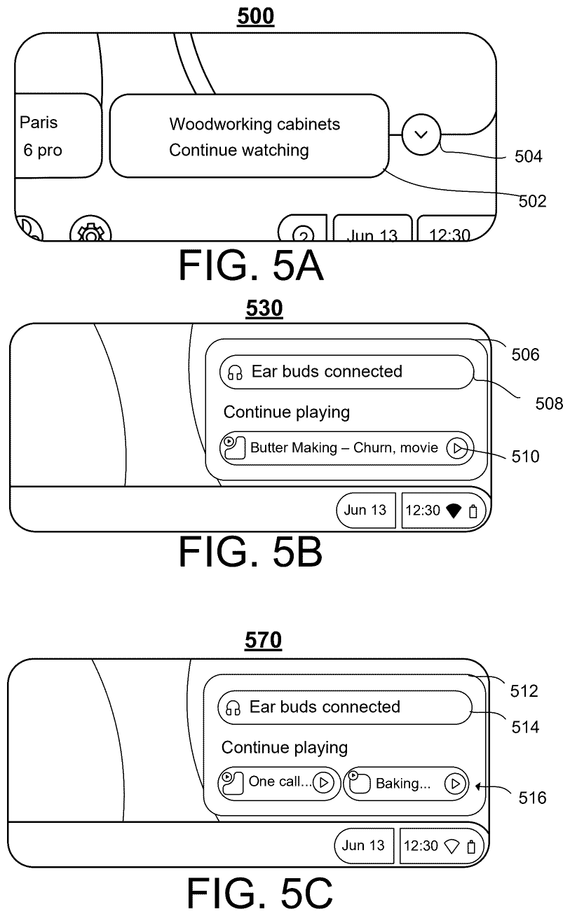

FIG. 5A depicts a media operating system interface 500 that may enable a user to continue playing a second media file that was playing on an external device. In response to receiving the indication from another device, the operating system may initiate a display of a transfer control accessible via the operating system. In examples, the operating system may determine that the second media file was being accessed and/or played on an external device via an application program communication from the other device. In an example, the second media file may have been previously playing on a tablet or smartphone device before the operating system interface 500 subsequently switched to a laptop. Operating system interface 500 may provide a transfer control 502 that may allow the user to continue playing the second media file on the new device on which operating system interface 500 is displayed. In examples, a user may be able to engage transfer control 502 by clicking on a dropdown menu 504.

FIG. 5B depicts an operating system interface 530, with an extended view of transfer control 502 once dropdown menu 504 has been selected. Playback control 506 may provide a selectable device control 508, similar to those displayed via selectable device controls 404. Operating system interface 530 may further include a transfer control 510. The selection of transfer control 510 may allow a user to continue playing a media file previously played on the selected device.

FIG. 5C depicts an operating system interface 570 with an extended view of transfer control 502. Playback control 512 may provide a selectable device control 514. In operating system interface 570, there may be two or more transfer controls 516. In an example, each two or more transfer controls 516 may comprise a media file that was being played on a different device. Operating system interface 570 may allow a user to pick up playing any media file that the user was engaging with on any related computing device.

In examples, a media user interface may display suggested media files related to the media files that the user has played on the operating system or any other device. In examples, the operating system may determine one or more suggested media files by receiving an application program communication from another device, a media streaming application, or a media streaming service.

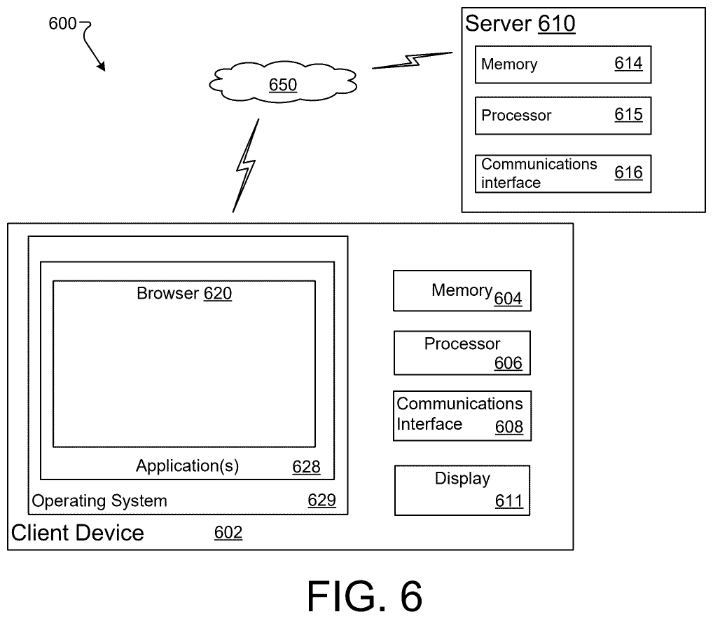

FIG. 6 depicts a system 600 that may execute the methods described herein, according to an example. System 600 includes a client device 602 and a server 610 in communication via a network or the network 650.

Client device 602 includes a memory 604, a processor 606, and a communications interface 608. Client device 602 is in communication with a display 611, which may be internal or external.

Client device 602 includes an operating system 629 which executes on processor 606. Operating system 629 may manage low level memory, processes, and hardware, in addition to providing services for applications to run on top of.

The client device 602 may include applications 628, which may execute on top of operating system 629. Applications 628 may represent specially programmed software configured to perform different functions. One of the applications may be the browser 620. The browser 620 may be configured to display webpages, execute web applications (e.g., applications executing in a browser tab), and the like. The browser 620 may include additional functionality in the form of browser extensions, e.g., a browser plug-in.

In examples, some applications 628 may execute independently of browser 620. In examples, some applications 628 may execute within a tab of the browser 620 or within a tab of browser 620. In examples, applications 628 executing within a tab of the browser 620 may be hosted by a website. In examples, applications 628 executing within a tab of the browser 620 may be hosted by a website and also include code downloaded and installed on the client device 602. In examples, applications 628 executing within a tab of the browser 620 may be downloaded and installed on the client device 602.

In some examples, the client device 602 may communicate with the server 610 over a network 650. The server 610 may be a computing device or computing devices that take the form of a number of different devices, for example a standard server, a group of such servers, or a rack server system. In some examples, the server 610 may be a single system sharing components such as processors and memories. The network 650 may include the Internet and/or other types of data networks, such as a local area network (LAN), a wide area network (WAN), a cellular network, satellite network, or other types of data networks. The network 650 may also include any number of computing devices (e.g., computer, servers, routers, network switches, etc.) that are configured to receive and/or transmit data within network 650. Network 650 may further include any number of hardwired and/or wireless connections. Server 610 includes a memory 614, a processor 615, and a communications interface 616. The server 610 may store in the memory 614 instructions that, when executed by the processor 615 cause the server 610 to perform operations, such as working with the client device 602 to generate a media user interface.

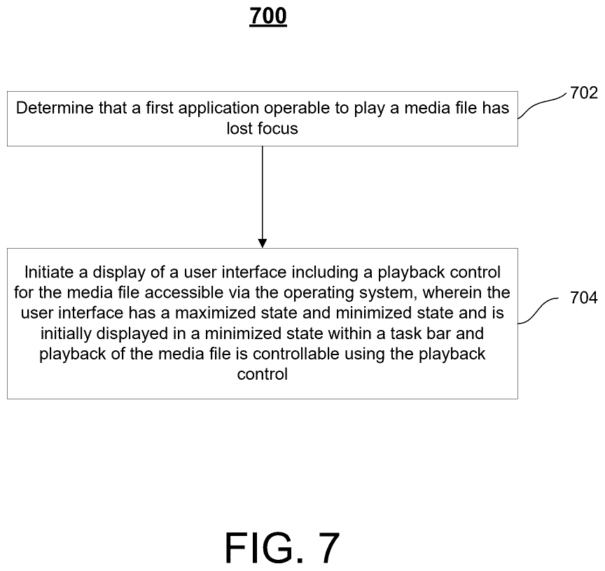

FIG. 7 is a flowchart of an example method 700 that may be used to initiate the display of a media user interface in a maximized state via the operating system with a playback control for a media file when an application operable to play the media file loses focus. In examples, the method 700 may include any combination of steps 702 and 704.

At step 702, it may be determined that an application operable to play a media file has lost focus. For example, tab 102 may lose focus, as described above.

At step 704, in response to determining that the application has lost focus, a display of a user interface including a playback control for the media file in a maximized state accessible via the operating system may be initiated, wherein the user interface is initially displayed in a minimized state within a task bar and playback of the media file is controllable using the playback control. For example, maximized media user interface 118 may be displayed with set of application playback controls 104, as described above.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for the purposes of describing example implementations. Example implementations, however, have many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

The terminology used herein is for the purpose of describing particular implementations only and is not intended to be limiting of example implementations. As used herein, the singular forms a, an, and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), Graphics Processing Units (GPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program computer-readable storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

In some aspects, the techniques described herein relate to a method, wherein the user interface in the second state displays a plurality of playback controls and the user interface in the first state displays a subset of the plurality of playback controls.

In some aspects, the techniques described herein relate to a method, wherein the user interface in the second state displays information associated with the media file that is not displayed in the first state.

In some aspects, the techniques described herein relate to a method, wherein initiating the display of the user interface in the second state includes determining that the application has lost focus and that the application is playing the media file.

In some aspects, the techniques described herein relate to a method, wherein the application is a first application executing on the operating system, the media file is a first media file, the playback control is a first playback control, and the method further includes: determining that a second application operable to play a second media file is executing; and including a second playback control for the second media file in the user interface.

In some aspects, the techniques described herein relate to a method, wherein the user interface further includes a selection control for a playback device, the method further including: receiving a selection of the selection control; and in response to receiving the selection, sending an instruction to the playback device to play the media file.

In some aspects, the techniques described herein relate to a method, further including: determining that the media file is playing on a transfer device; and including a transfer control in the user interface, the transfer control being selectable by a user to play the media file on a local device.

In some aspects, the techniques described herein relate to a method, wherein the playback control further includes at least one of a play control, a pause control, a fast forward control, or a rewind control.

In some aspects, the techniques described herein relate to a method, wherein the playback control further includes an interruptive content bypass control operable to, upon selection, skip over interruptive content playing as part of playback of the media file.

In some aspects, the techniques described herein relate to a system, wherein the user interface in the maximized state displays a plurality of playback controls and the user interface in the minimized state displays a subset of the plurality of playback controls.

In some aspects, the techniques described herein relate to a system, wherein the user interface in the maximized state displays information associated with the media file that is not displayed in the minimized state.

In some aspects, the techniques described herein relate to a system, wherein initiating the display of the user interface in the maximized state includes determining that the application has lost focus and that the application is playing the media file.

In some aspects, the techniques described herein relate to a system, wherein the application is a first application executing on the operating system, the media file is a first media file, the playback control is a first playback control, and the memory is further configured with code operable to: determine that a second application operable to play a second media file is executing; and include a second playback control for the second media file in the user interface.

In some aspects, the techniques described herein relate to a system, wherein the playback control includes a function that the application does not include.

In some aspects, the techniques described herein relate to a non-transitory computer-readable medium, wherein the user interface further includes a selection control for a playback device, the instructions further causing the processor to: receive a selection of the selection control; and in response to receiving the selection, send an instruction to the playback device to play the media file.

In some aspects, the techniques described herein relate to a non-transitory computer-readable medium, the instructions further causing the processor to: determine that the media file is playing on a transfer device; and include a transfer control in the user interface, the transfer control being selectable by a user to play the media file on a local device.

In some aspects, the techniques described herein relate to a non-transitory computer-readable medium, wherein the playback control further includes at least one of a play control, a pause control, a fast forward control, or a rewind control.

In some aspects, the techniques described herein relate to a non-transitory computer-readable medium, wherein the playback control further includes an interruptive content bypass control operable to, upon selection, skip over interruptive content playing as part of playback of the media file.

What is claimed is:

1. A method performed by an operating system, the method comprising:
determining that an application operable to play a media file has lost focus; and
in response to determining that the application has lost focus, initiating a display of a user interface including a playback control for the media file accessible via the operating system, wherein the user interface has a second state and a first state and is initially displayed in the first state within a task bar and playback of the media file is controllable using the playback control.

2. The method of claim 1, wherein the user interface in the second state displays a plurality of playback controls and the user interface in the first state displays a subset of the plurality of playback controls.

3. The method of claim 1, wherein the user interface in the second state displays information associated with the media file that is not displayed in the first state.

4. The method of claim 1, wherein initiating the display of the user interface in the second state includes determining that the application has lost focus and that the application is playing the media file.

5. The method of claim 1, wherein the application is a first application executing on the operating system, the media file is a first media file, the playback control is a first playback control, and the method further comprises:
determining that a second application operable to play a second media file is executing; and
including a second playback control for the second media file in the user interface.

6. The method of claim 1, wherein the user interface further includes a selection control for a playback device, the method further comprising:
receiving a selection of the selection control; and
in response to receiving the selection, sending an instruction to the playback device to play the media file.

7. The method of claim 1, further comprising:
determining that the media file is playing on a transfer device; and
including a transfer control in the user interface, the transfer control being selectable by a user to play the media file on a local device.

8. The method of claim 1, wherein the playback control further includes at least one of a play control, a pause control, a fast forward control, or a rewind control.

9. The method of claim 1, wherein the playback control further includes an interruptive content bypass control operable to, upon selection, skip over interruptive content playing as part of playback of the media file.

10. A system comprising:
a processor; and
a memory configured with code operable to:
determine that an application operable to play a media file has lost focus; and
in response to determining that the application has lost focus, initiate a display of a user interface including a playback control for the media file accessible via an operating system, wherein the user interface has a maximized state and minimized state and is initially displayed in the minimized state within a task bar and playback of the media file is controllable using the playback control.

11. The system of claim 10, wherein the user interface in the maximized state displays a plurality of playback controls and the user interface in the minimized state displays a subset of the plurality of playback controls.

12. The system of claim 10, wherein the user interface in the maximized state displays information associated with the media file that is not displayed in the minimized state.

13. The system of claim 10, wherein initiating the display of the user interface in the maximized state includes determining that the application has lost focus and that the application is playing the media file.

14. The system of claim 10, wherein the application is a first application executing on the operating system, the media file is a first media file, the playback control is a first playback control, and the memory is further configured with code operable to:
determine that a second application operable to play a second media file is executing; and
include a second playback control for the second media file in the user interface.

15. The system of claim 10, wherein the playback control includes a function that the application does not include.

16. A non-transitory computer-readable medium storing instructions that, when executed by a processor, cause a processor to:
determine that a browser tab operable to control playback of a media file has lost focus; and
in response to determining that the browser tab has lost focus, initiate a display of a user interface in a maximized state including a playback control for the media file accessible via an operating system, wherein the user interface is initially displayed in a minimized state within a task bar and playback of the media file is controllable based on the playback control.

17. The non-transitory computer-readable medium of claim 16, wherein the user interface further includes a selection control for a playback device, the instructions further causing the processor to:
receive a selection of the selection control; and
in response to receiving the selection, send an instruction to the playback device to play the media file.

18. The non-transitory computer-readable medium of claim 16, the instructions further causing the processor to:
determine that the media file is playing on a transfer device; and
include a transfer control in the user interface, the transfer control being selectable by a user to play the media file on a local device.

19. The non-transitory computer-readable medium of claim 16, wherein the playback control further includes at least one of a play control, a pause control, a fast forward control, or a rewind control.

20. The non-transitory computer-readable medium of claim 16, wherein the playback control further includes an interruptive content bypass control operable to, upon selection, skip over interruptive content playing as part of playback of the media file.
